(19) United States
(12) Patent Application Publication
(10) Pub. No.: US 2024/0036328 A1
(43) Pub. Date: Feb. 1, 2024

(54) DISPLAY SYSTEM INCLUDING CURVED DIFFUSER

(71) Applicant: Meta Platforms Technologies, LLC, Menlo Park, CA (US)

(72) Inventor: Brandon Michael Hellman Friedman, Redmond, WA (US)

(21) Appl. No.: 18/359,880

(22) Filed: Jul. 27, 2023

Related U.S. Application Data
(60) Provisional application No. 63/392,472, filed on Jul. 26, 2022.

(51) Int. Cl. G02B 27/01; G02B 17/08; G02B 5/02

(52) U.S. Cl. CPC G02B 27/0172; G02B 17/08; G02B 5/0284; G02B 5/0278; G02B 2027/0178; G02B 2027/011

(57) ABSTRACT

A display system may include a diffuser having a curved surface, a display device positioned to emit light that is focused on the curved surface of the diffuser, at least one viewing optic, and an eye box. The light focused on the curved surface of the diffuser may have a first cone angle and is diffused by the diffuser such that light output from the diffuser has a second cone angle, the second cone angle being larger than the first cone angle. Additionally, the light output from the diffuser may propagate through the at least one viewing optic to the eye box. Various other devices, systems, and methods are also disclosed.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a diagram illustrating field curvature of an example lens according to some embodiments.

FIG. 2 is a diagram illustrating an example display system that includes a curved reflective diffuser according to some embodiments.

FIG. 3A is a diagram illustrating a projection path of the example display system of FIG. 2 according to some embodiments.

FIG. 3B is a diagram illustrating a viewing path of the example display system of FIG. 2 according to some embodiments.

FIG. 4 is a diagram illustrating an example display system that includes a curved transmissive diffuser according to some embodiments.

FIG. 5 is a diagram illustrating a portion of an example display system that includes a curved diffuser according to some embodiments.

FIG. 6 is a diagram illustrating a portion of an example display system that includes a curved diffuser according to some embodiments.

FIG. 7 is a flow diagram illustrating an example method of forming a display system according to some embodiments.

FIG. 8 is an illustration of an example augmented-reality glasses that may be used in connection with embodiments of this disclosure.

FIG. 9 is an illustration of an example virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

Imaging lenses utilized in display devices may be limited by various optical aberrations. One such aberration is known as field curvature, which can be described as a predisposition to focus light at a curved image “plane” (i.e., field surface), rather than a flat plane. Field curvature is typically attributed to curved focusing surfaces of optical elements, which project images in a curved, rather than flat, manner. The effect of the field curvature aberration may be more pronounced in regions further from the optical axis of a focusing lens. In some display systems, field curvature has been compensated by using additional optical elements and surfaces within the systems. However, the inclusion of additional optical elements can be size, weight, and cost prohibitive for various display devices. In headset display systems (e.g., virtual-reality headsets, augmented-reality headsets, etc.), field curvature may be resolved, for example, using certain lenses (e.g., Fresnel lenses, pancake lenses, etc.) that inherently compensate for field curvature. However, such lenses may produce stray light and/or diffraction effects that can reduce contrast and/or cause image artifacts. Additionally, display brightness may be undesirably degraded in virtual-reality devices due to low transmission efficiency and non-ideal coatings utilized in some cases may present contrast challenges. Some lenses may also be cost-prohibitive due to high tolerances required by their alignment sensitivity. While curved displays may address field curvature aberrations, such displays suitable for use in various systems, including virtual-reality systems, are not commonly available.

The present disclosure is generally directed to display systems and devices including curved diffusers that may compensate for optical aberrations, such as field curvature aberrations, while providing a sufficiently large eye box for users of the devices. The curved diffusers may enable the use of relatively small projectors and displays without requiring additional optical components to provide a suitably large eye box. A curved reflective or transmissive diffuser may follow a curved path that matches the field curvatures of both projected light incident on the diffuser and the viewing optics to which the diffused light is transmitted. Accordingly, curved diffusers may be utilized to increase the cone angle of light output from displays or projectors to accommodate viewing optics for presenting images covering an increased field of view for users.

Features from any of the embodiments described herein may be used in combination with one another in accordance with the general principles described herein. These and other embodiments, features, and advantages will be more fully understood upon reading the following detailed description in conjunction with the accompanying drawings and claims.

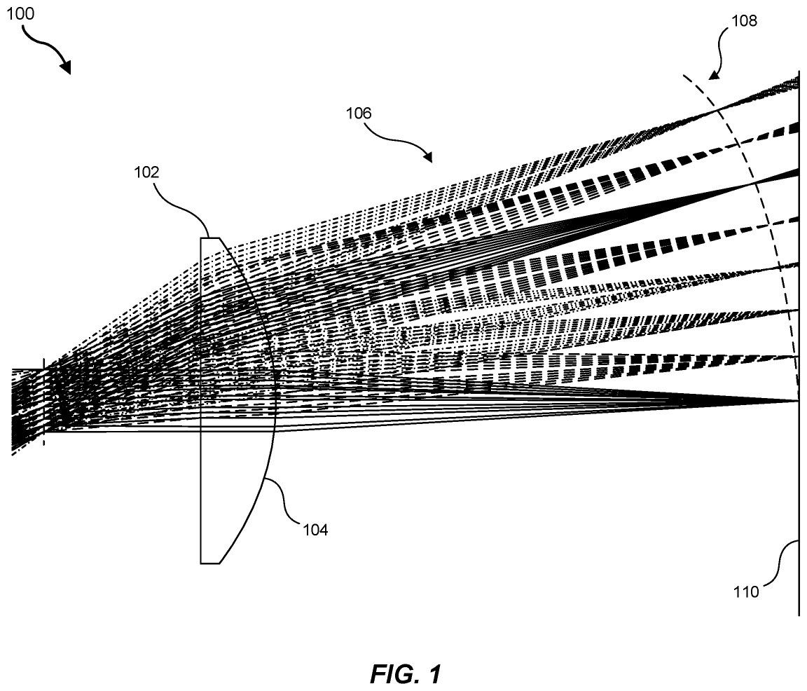

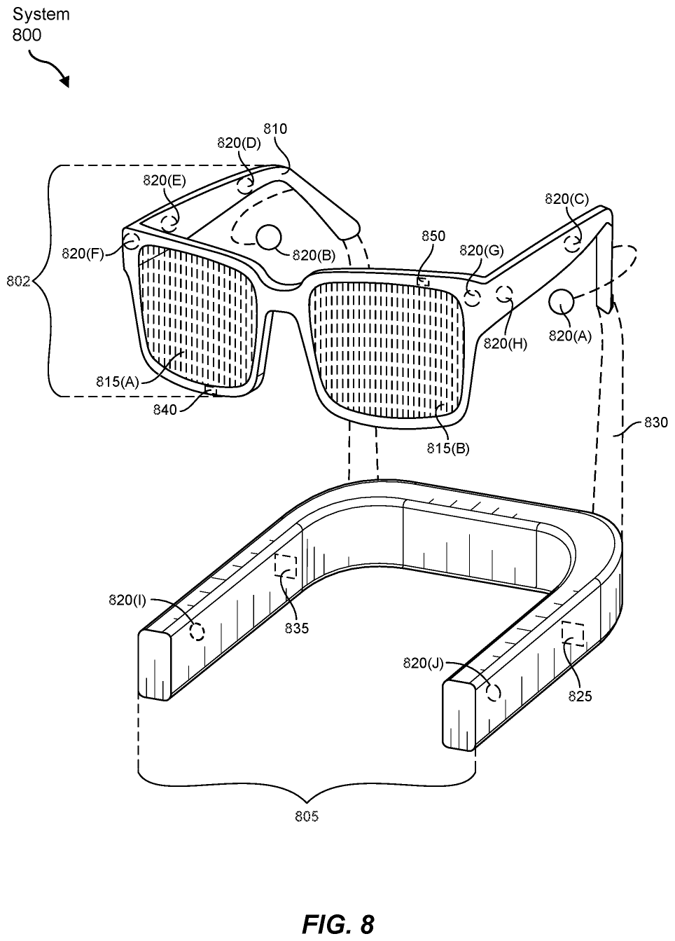

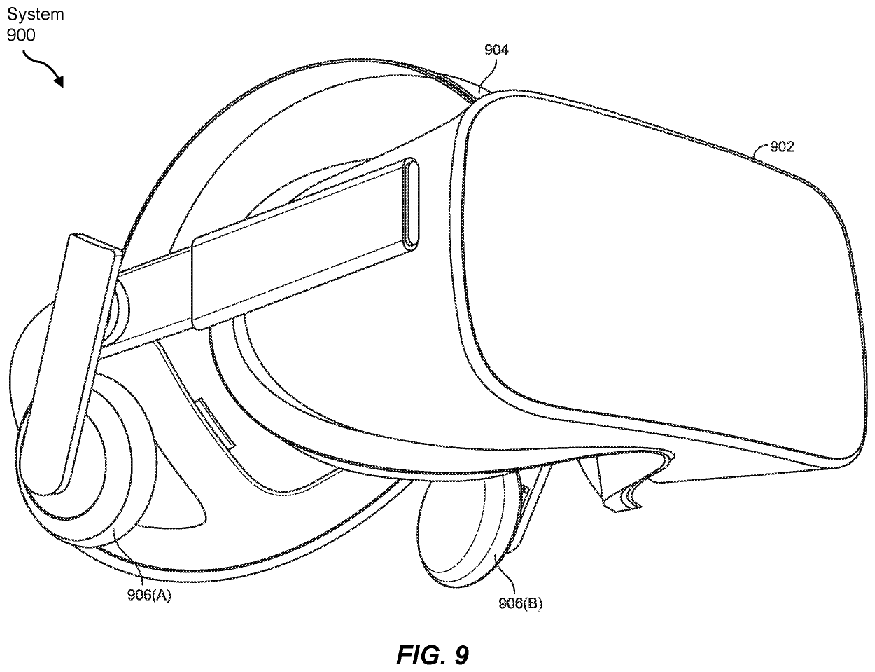

The following will provide, with reference to FIGS. 1-9, a detailed description of display systems having optical components, including curved diffusers, and methods of manufacturing and using the same. The discussion associated with FIGS. 1-7 relates to the architecture, operation, and manufacturing of various example display systems and devices. The discussion associated with FIGS. 8 and 9 relates to exemplary virtual reality and augmented reality devices that may include display systems and devices as disclosed herein.

FIG. 1 shows a diagram 100 illustrating the field curvature of an example lens 102 having a curved lens surface 104 (e.g., a convex spherical lens surface). As shown in this figure, lens 102 has a predisposition to focus light (represented by light paths 106) at a curved field surface 108 that departs from a conventional planar display surface 110. Because curved field surface 108 departs from planar display surface 110, an image projected from planar display surface 110 through lens 102 may include field curvature aberrations in regions outside an optical axis of lens 102 (assuming the optical axis is focused on planar display surface 110). The effect of the field curvature aberration may become more apparent to a viewer proceeding outward from the optical axis of lens 102 as the image from planar display surface 110 becomes progressively less focused.

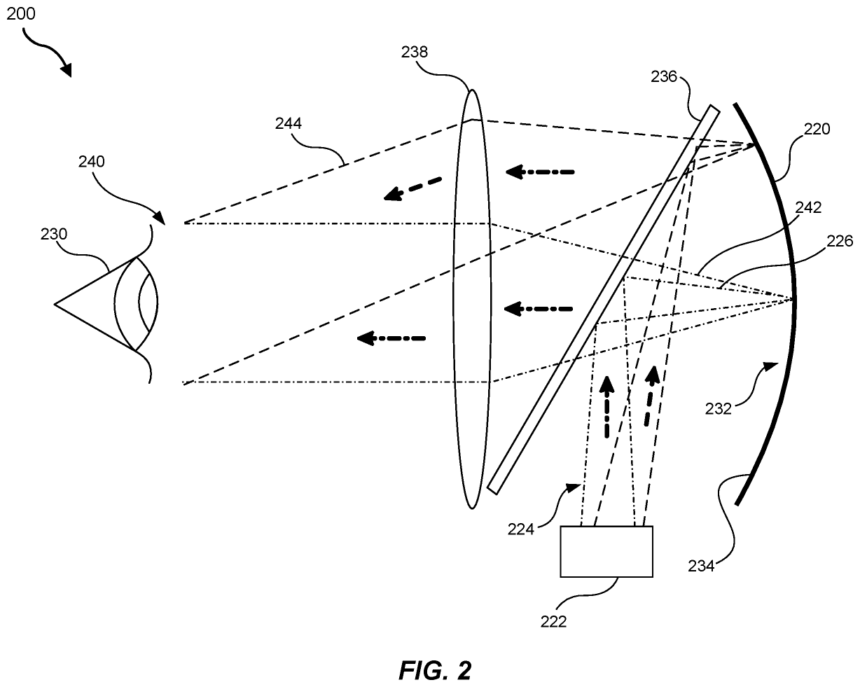

FIG. 2 illustrates a display system 200 that includes a curved reflective diffuser 220, in accordance with at least one embodiment. In some examples, display system 200 may be any suitable head-mounted-display system, such as a virtual-reality system having optical components mounted within a display housing that may be secured over a user's eyes (see, e.g., FIG. 9). Additionally or alternatively, display system 200 may include any other suitable type of wearable artificial-reality system, such as an augmented-reality or mixed-reality system configured to display virtual images overlapping real-world images.

As shown in FIG. 2, a display device 222, such as a projector, may form an intermediate image 232 on a concave intermediate image surface 234 of curved reflective diffuser 220. In some examples, display system 200 may include a beamsplitter 236, as shown, to reflect light emitted from display device 222 toward curved reflective diffuser 220 so that display device 222 may be located in a region outside a path of light reflected from curved reflective diffuser 220. As such, projected light 224 from display device 222 may be reflected by beamsplitter 236 toward curved reflective diffuser 220 to form intermediate image 232 on concave intermediate image surface 234 of curved reflective diffuser 220. In some examples, the cone angle (represented by projected light cone 226) of projected light 224 output by display device 222 may be too small to directly achieve a degree of magnification required to produce a sufficiently large eye box 240 for a viewer. Accordingly, display device 222 may not directly produce an adequately large eye box 240 for user's eye 230, which is disposed at eye box 240, in conjunction with conventional viewing optics alone.

Curved diffusers, as described herein, may include any suitable type of reflective and/or transmissive diffusers having one or more curved surfaces for reflecting and/or transmitting diffused light. In some examples, a diffuser may have a reflective or semi-reflective surface, such as a metallic surface, having surface features (e.g., regular or irregular surface structures) that are configured to enlarge the cone angle of reflected light. In at least one example, a reflective diffuser may include a transmissive or semi-transmissive diffusing layer coating a reflective surface. In some examples, a transmissive diffuser may be at least partially transmissive and may be configured to enlarge the cone angle of light passing through the diffuser. A transmissive or partially transmissive diffusing material may include any suitable material or combination of materials, including additives such as diffractive particles. The diffusing material may additionally or alternatively include surface features and/or internal features that diffuse light passing through the diffusing layer. In at least one example, correlations between surface and/or internal features (e.g., feature diameters, surface roughness, patterning, etc.) may be used to produce curved diffusers that diffuse light to a specified extent, resulting in a desired degree of increase in light cone angles. In at least one example, a thickness and/or or volume of the curved diffuser and/or a diffusing layer coating a reflective surface of the curved diffuser may be selected to diffuse light to a desired extent without degrading image contrast and/or focus (e.g., a layer may be selected to provide a desired amount of light diffusion while remaining suitably thin so as to avoid a noticeable impact to image quality).

Curved reflective diffuser 220 may be located such that intermediate image 232 is focused on concave intermediate image surface 234. Curved reflective diffuser 220 may diffuse the projected light 224 from display device 222 to expand the cone angle (i.e., increase the etendue) of light reflected from intermediate image surface 234 toward viewing optics 238 of display system 200. Viewing optics 238 may include one or more lenses and/or other optical components configured to produce a final image viewable by a user of display system 200. The expanded cone angle of diffused light reflected from intermediate image surface 234 of curved reflective diffuser 220 is represented by expanded light cone 242 in FIG. 2. As illustrated, light reflected from intermediate image surface 234 may pass through beamsplitter 236 to viewing optics 238. Intermediate image surface 234 of curved reflective diffuser 220 may be selectively curved to match or substantially match both the field curvature of display device 222 and the field curvature of viewing optics 238, which may include at least one lens to focus a final image at eye box 240.

Viewing optics 238 may direct the expanded light from curved reflective diffuser 220 toward eye box 240, as shown in FIG. 2, to form a final image at eye box 240. The light output by viewing optics 238 is represented by final image light path 244 in FIG. 2. The expanded light from curved reflective diffuser 220 may enable formation of a larger final image at eye box 240 without necessarily increasing the size of display device 222 or utilizing additional optical elements, such as a Fresnel and/or pancake lens. Accordingly, in some examples, a relatively small display device 222, such as a projector or other display device suitable for use in an augmented-reality or virtual-reality headset (e.g., a small-scale light-emitting diode (LED) display, a two-dimensional scanning display, a μLED display, etc.), can be utilized in display system 200. Additionally, because intermediate image surface 234 of curved reflective diffuser 220 may be selectively curved to match both the field curvature of display device 222 and the field curvature of viewing optics 238, the final image image formed by viewing optics may be substantially free of optical aberrations, including field curvature aberrations.

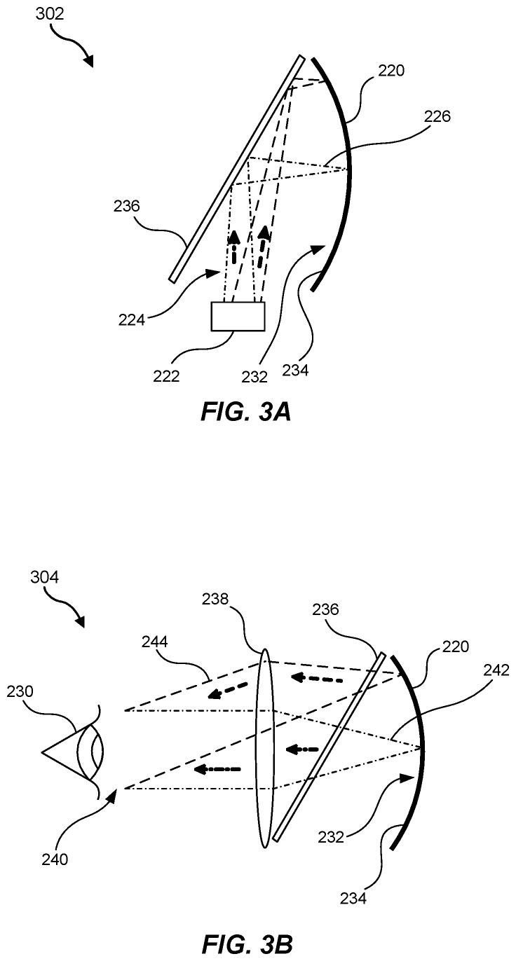

FIGS. 3A and 3B show portions of display system 200 illustrated in FIG. 2. FIG. 3A illustrates a projection path 302 of light from display device 222 to concave intermediate image surface 234 of curved reflective diffuser 220. FIG. 3B illustrates a viewing path 304 of light from intermediate image surface 234 of curved reflective diffuser 220 to eye box 240. As shown in FIG. 3A, beamsplitter 236 may be placed between curved reflective diffuser 220 and eye box 240 and may be oriented to reflect projected light 224 from display device 222 toward curved reflective diffuser 220. The projected light 224 reflected by beamsplitter 236 may be focused on intermediate image surface 234 of curved reflective diffuser 220, as shown in FIG. 3A. Additionally, as shown in FIG. 3B, beamsplitter 236 may transmit light reflected from intermediate image surface 234 of curved reflective diffuser 220 toward viewing optics 238. Paths of light from curved reflective diffuser 220 transmitted through beamsplitter 236 may remain substantially unchanged such that expanded light cone 242 is substantially the same before and after passing through beamsplitter 236.

The curvature of intermediate image surface 234 of curved reflective diffuser 220 may be configured to compensate for field curvature of both projection path 302 and viewing path 304. Projected light 224 from display device 222 that is focused on intermediate image surface 234 of curved reflective diffuser 220 may be diffused during reflection. Accordingly, the relatively smaller projected light cone 226 of projected light 224 from display device 222 may be diffused and reflected by intermediate image surface 234 as an expanded light cone 242 toward viewing optics 238, enabling viewing optics 238 to form a sufficiently large eye box 240 for the user.

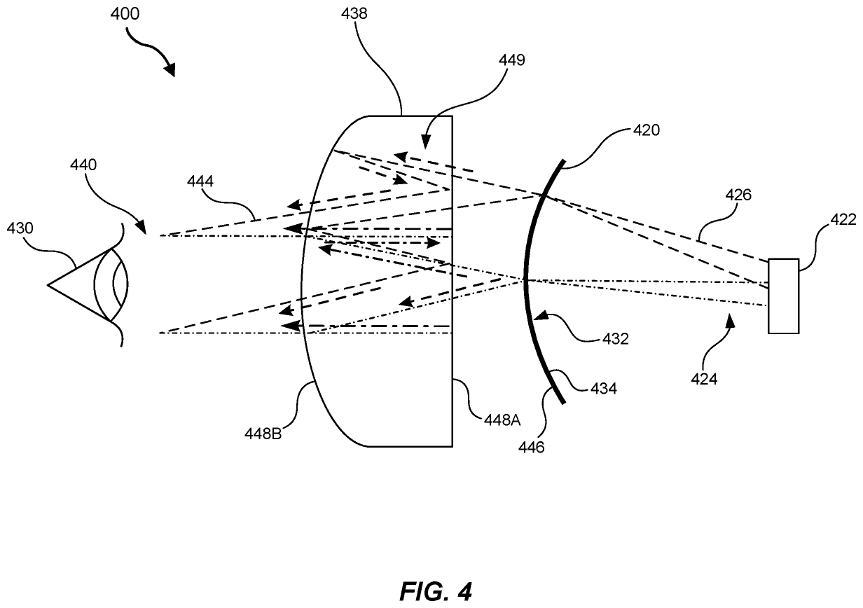

FIG. 4 illustrates a display system 400 that includes a curved transmissive diffuser 420 in accordance with at least one embodiment. As shown in this figure, a display device 422, such as a projector, may form an intermediate image 432 on a concave intermediate image surface 434 of curved transmissive diffuser 420. In this example, projected light 424 may be diffused as it passes through curved transmissive diffuser 420 so that light having an increased cone angle (represented by expanded light cone 442) is emitted from a convex diffuser output surface 446 of curved transmissive diffuser 420 toward viewing optics 438. In some examples, intermediate image surface 434 may be curved to match or substantially match a curvature of diffuser output surface 446. Viewing optics 438 may then direct the expanded light from curved transmissive diffuser 420 toward an eye box 440, which is configured to be located at or near a user's eye 430 when display system 400 is worn by the user. The light output by viewing optics 438, which forms a final image at eye box 440, is represented by final image light path 444 in FIG. 4.

In some examples, viewing optics 438 may include and/or may be utilized in conjunction with a beamsplitter, such as a beamsplitter having pancake surfaces 448 as illustrated in FIG. 4. As shown, a beamsplitter, or beamsplitter functionality, may be integrated in viewing optics 438. For example, viewing optics 438 may include beamsplitter pancake surfaces 448 having coatings that selectively transmit or internally reflect light (represented by internal light paths 449) depending on incidence angles of the light. In this example, output surface 447 of viewing optics 438 may function to both internally reflect light receive light and to focus outgoing light toward eye box 440. A pancake-type projection and/or viewing lens may be useful to facilitate field curvature matching between the projector and the viewing optics. In additional embodiments, such a beamsplitter may be excluded where, for example, curved transmissive diffuser 420 can alone be structured to match field curvatures of both display device 422 and viewing optics 438. In these examples, display system 400 may include viewing optics 438 without a beamsplitter or beamsplitter functionality (see, e.g., optics 238 in FIG. 2).

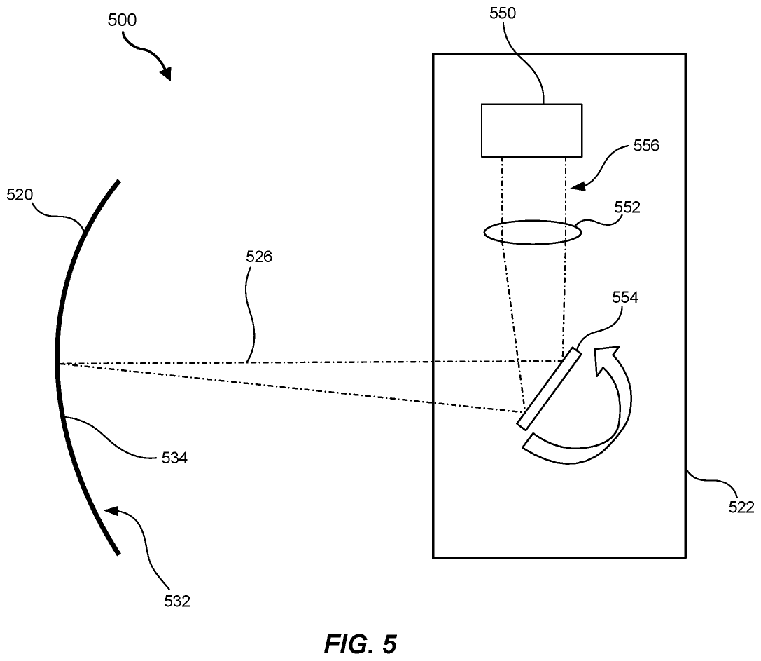

FIG. 5 illustrates portion of a display system 500 that includes a curved diffuser 520 in accordance with at least one embodiment. The portion of display system 500 shown in this figure may include a projection path portion (see, e.g., FIG. 3A). As shown in this figure, a display device 522, such as a two-dimensional scanning projector, may include a light source 550, such as a laser and/or light-emitting diode (LED), that emits one or more beams of light 556. In some examples, the light emitted by light source 550 may be collimated. Display device 522 may also include focusing optics 552 (e.g., one or more focusing lenses) and a rotating mirror 554, such as a micro-electromechanical systems (MEMS) two-dimensional scanning mirror. In some embodiments, focusing optics 552 may focus the one or more light beams of light 556 emitted from 550 such that the focused light (represented by projected light cone 526) is directed toward rotating mirror 554. Rotating mirror 554 may reflect the focused light toward curved diffuser 520, which may be a transmissive or reflective diffuser in accordance with other embodiments described herein. In some examples, light reflected by rotating mirror 554 may be focused on a concave intermediate image surface 534 of curved diffuser 520. Emission of light 556 by light source 550 may be timed with scanning positions and movements of rotating mirror 554 to form an intermediate image 532 on intermediate image surface 534 of curved diffuser 520. In some examples, light source 550 may emit multiple colors and/or intensities of light that may be selectively emitted in a time sequence with positional orientations of rotating mirror 554.

While FIG. 5 illustrates a beam of collimated light 556 focused by focusing optics 552, in some embodiments, light source 550 may alternatively emit a narrower collimated beam that is reflected by rotating mirror 554 to form intermediate image 532 on concave intermediate image surface 534. For example, the collimated beam, such as a laser beam or other collimated beam, may be directed by concave intermediate image surface 534 toward curved diffuser 520 without further focusing the collimated light via additional focusing optics.

Light 556 from light source 550 focused on or directed to concave intermediate image surface 534 of curved diffuser 520 by concave intermediate image surface 534 may then be diffused as it is reflected by curved diffuser 520 (see, e.g., curved reflective diffuser 220 shown in FIGS. 2-3B) or as it passes through curved diffuser 520 (see, e.g., curved transmissive diffuser 420 in FIG. 4). Light having an increased cone angle may be reflected or emitted from curved diffuser 520 toward a viewing optic and an eye box of the display system in accordance with any of the embodiments disclosed herein.

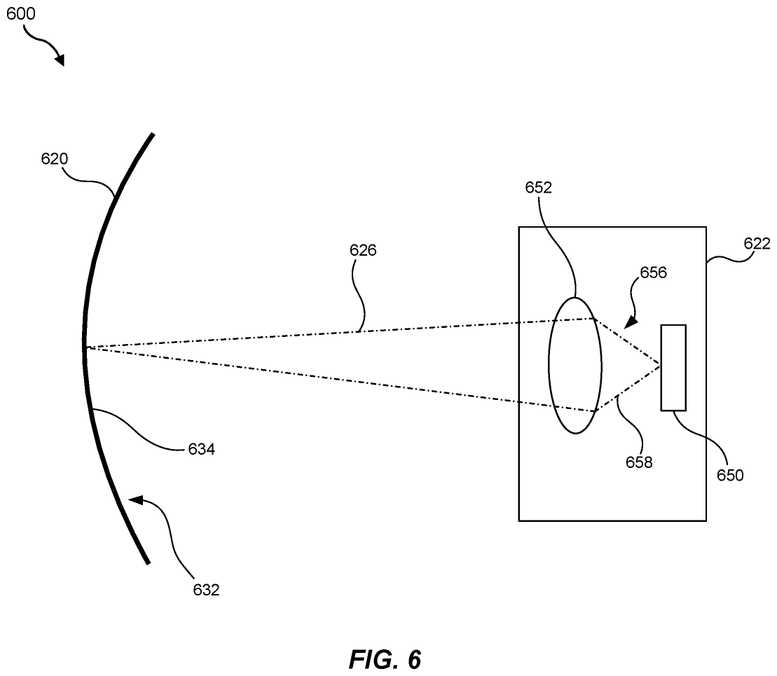

FIG. 6 illustrates portion of a display system 600 that includes a curved diffuser 620 in accordance with at least one embodiment. The portion of display system 600 shown in this figure may include a projection path portion (see, e.g., FIG. 3A). As shown in this figure, a display device 622, such as a small LED display or projector, may include a relatively small display 650 having a display area that is smaller than curved diffuser 620. Emitted light 656 from display 650 may be magnified by projection optics 652 such that the light projected from projection optics 652 is focused on a concave intermediate image surface 634 of curved diffuser 620 to form an intermediate image 632 on intermediate image surface intermediate image surface 634. Projection optics 652 may include at least one lens that magnifies and focuses the emitted light 656 from display 650 such that a larger intermediate image 632 than that emitted by display 650 is focused on intermediate image surface 634 of curved diffuser 620. Accordingly, as shown in FIG. 6, projection optics 652 may reduce the cone angle of emitted light 656 from an emitted light cone 658 to a projected light cone 626 having a narrower cone angle than emitted light cone 658.

Light focused on intermediate image surface 634 of curved diffuser 620 may be diffused as it is reflected by curved diffuser 620 (see, e.g., the curved reflective diffuser shown in FIGS. 2-3B) or as it passes through curved diffuser 620 (see, e.g., the curved transmissive diffuser shown in FIG. 4). Light having an increased cone angle may then be reflected or emitted from curved diffuser 620 toward a viewing optic and an eye box in accordance with any of the disclosed embodiments disclosed herein.

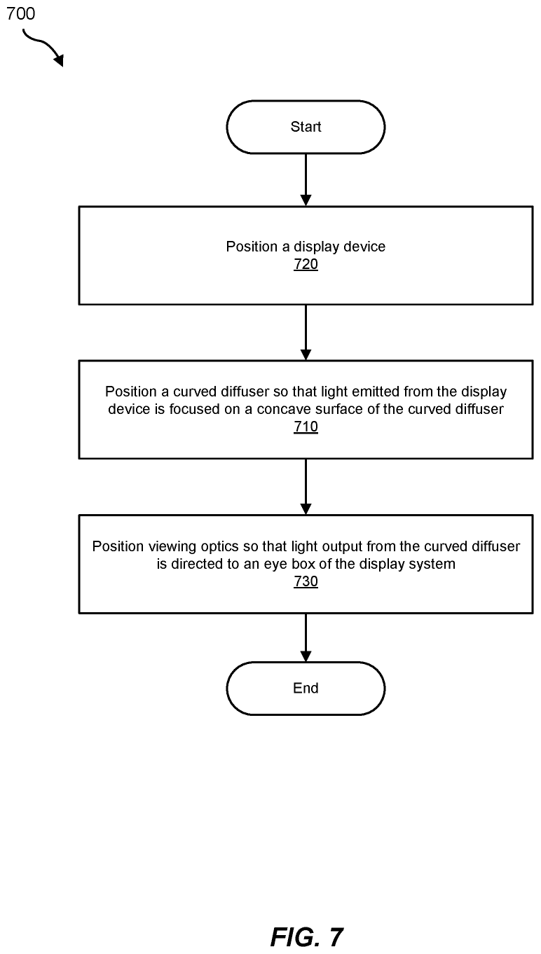

FIG. 7 is a flow diagram illustrating a method 700 of forming a display system according to at least one embodiment of the present disclosure. At operation 710, a display device may be positioned. Operation 710 may be performed in a variety of ways. For example, the display device may be mounted within a suitable portion of the display system, such as an enclosed location within a headset housing (e.g., an augmented reality or virtual reality housing as hown in FIGS. 8 and 0).

At operation 720, a curved diffuser may be positioned so that light emitted from the display device is focused on a concave surface of the curved diffuser. Operation 720 may be performed in a variety of ways. For example, light from a projector or small display (e.g., an LED display) may be focused on a concave intermediate image surface of the curved diffuser in any of the ways disclosed herein. The curved diffuser may include a reflective or transmissive diffuser that is positioned to emit diffused light toward any suitable viewing optics, as described herein. In some examples, the curved diffuser may be mounted within an enclosed portion of the display system, such a location within a headset housing that also encloses the display device.

At operation 730, viewing optics may be positioned so that light output from the curved diffuser is directed to an eye box of the display system. Operation 730 may be performed in a variety of ways. The curved diffuser may reflect or transmit diffused light toward the viewing optics, as described herein. The viewing optics may direct the light received from the curved differ to an eye box of the display system that is viewable to a user while wearing the display system. In additional embodiments, other components of the display system, as explained and described above with reference to FIGS. 2-6, may be mounted to the system (e.g., within a virtual-reality system housing, augmented-reality glasses frame, etc.) in suitable locations for proper viewing and operation.

Accordingly, the present disclosure includes display systems, devices, and methods that include curved diffusers that enable a sufficiently large eye box to be produced for users using a variety of display devices, including smaller display devices and projectors. The curved diffusers enable the use of relatively small projectors and displays devices without requiring additional optical components to provide the suitably large eye box. A curved reflective or transmissive diffuser may follow a curved path that matches the field curvatures of both projected light incident on the diffuser and viewing optics to which the diffused light is transmitted. Accordingly, curved diffusers may be utilized to increase the cone angle of light output from displays or projectors to accommodate viewing optics for presenting images covering an increased field of view to users.

### EXAMPLE EMBODIMENTS

Example 1: A display system includes 1) a diffuser having a curved surface, 2) a display device positioned to emit light that is focused on the curved surface of the diffuser, 3) at least one viewing optic, and 4) an eye box, where i) the light focused on the curved surface of the diffuser has a first cone angle and is diffused by the diffuser such that light output from the diffuser has a second cone angle, ii) the second cone angle is larger than the first cone angle, and iii) the light output from the diffuser propagates through the at least one viewing optic to the eye box.

Example 2: The display system of Example 1, where the diffuser is reflective.

Example 3: The display system of Example 2, further including a beamsplitter positioned between the diffuser and the eye box, where the light emitted from the display device is reflected from a surface of the beamsplitter toward the curved surface of the diffuser, and the light output from the diffuser transmits through the beamsplitter

Example 4: The display system of Example 1, where the diffuser is transmissive.

Example 5: The display system of any of Examples 1-4, where the light emitted from the display device and focused on the curved surface of the diffuser forms an intermediate image on the curved surface of the diffuser.

Example 6: The display system of any of Examples 1-5, where the light that propagates through the at least one viewing optic forms a final image that is viewable at the eye box.

Example 7: The display system of any of Examples 1-6, where the display device is a projector having a scanning mirror and the scanning mirror reflects light from the projector toward the diffuser.

Example 8: The display system of Example 7, where the projector includes a focusing optic to focus light from the light source toward the scanning mirror.

Example 9: The display system of Example 7, where the projector includes a laser emitter.

Example 10: The display system of any of Examples 1-9, where the display device includes at least one of a light-emitting diode (LED) display or a μLED display.

Example 11: The display system of any of Examples 1-10, where the display device includes at least one of a laser projector or an LED projector.

Example 12: The display system of any of Examples 1-11, where the intermediate image is formed on a concave surface of the diffuser.

Example 13: The display system of Example 12, where the diffuser is transmissive and the light forming the intermediate image on the concave surface of the diffuser propagates through the diffuser and is output from a convex surface of the diffuser.

Example 14: The display system of Example 12, where the concave surface of the diffuser is reflective and the light forming the intermediate image on the concave surface of the diffuser is reflected from the reflective surface of the diffuser.

Example 15: The display system of Example 14, where the light forming the intermediate image on the concave surface of the diffuser is diffused through a layer coating the reflective surface of the diffuser.

Example 16: The display system of Example 14, where the at least one viewing optic further includes a beamsplitter

Example 17: A display system includes a diffuser having a curved surface and a display device positioned to emit light that is focused on the curved surface of the diffuser, where the light focused on the curved surface of the diffuser has a first cone angle and is diffused by the diffuser such that light output from the diffuser has a second cone angle and the second cone angle is larger than the first cone angle.

Example 18: The display system of Example 17, where the diffuser is reflective.

Example 19: The display system of Example 17, where the diffuser is transmissive.

Example 20: A method that includes 1) positioning a display device, 2) positioning a curved diffuser so that light emitted from the display device is focused on a concave surface of the curved diffuser, and 3) positioning viewing optics so that light output from the curved diffuser is directed to an eye box of the display system.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 800 in FIG. 8) or that visually immerses a user in an artificial reality (such as, e.g., virtual-reality system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, augmented-reality system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While augmented-reality system 800 includes two displays, embodiments of this disclosure may be implemented in augmented-reality systems with a single NED or more than two NEDs.

In some embodiments, augmented-reality system 800 may include one or more sensors, such as sensor 840. Sensor 840 may generate measurement signals in response to motion of augmented-reality system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, augmented-reality system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While augmented-reality system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), augmented-reality device 800 may simulate binaural hearing and capture a 3D stereo sound field around about a user's head. In some embodiments, acoustic transducers 820(A) and 820(B) may be connected to augmented-reality system 800 via a wired connection 830, and in other embodiments acoustic transducers 820(A) and 820(B) may be connected to augmented-reality system 800 via a wireless connection (e.g., a BLUETOOTH connection). In still other embodiments, acoustic transducers 820(A) and 820(B) may not be used at all in conjunction with augmented-reality system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the augmented-reality system 800. In some embodiments, an optimization process may be performed during manufacturing of augmented-reality system 800 to determine relative positioning of each acoustic transducer 820 in the microphone array.

In some examples, augmented-reality system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to augmented-reality system 800. In the embodiment of FIG. 8, neckband 805 may include two acoustic transducers (e.g., 820(1) and 820(J)) that are part of the microphone array (or potentially form their own microphone subarray). Neckband 805 may also include a controller 825 and a power source 835.

Acoustic transducers 820(1) and 820(J) of neckband 805 may be configured to detect sound and convert the detected sound into an electronic format (analog or digital). In the embodiment of FIG. 8, acoustic transducers 820(1) and 820(J) may be positioned on neckband 805, thereby increasing the distance between the neckband acoustic transducers 820(1) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or augmented-reality system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which augmented-reality system 800 includes an inertial measurement unit, controller 825 may compute all inertial and spatial calculations from the IMU located on eyewear device 802. A connector may convey information between augmented-reality system 800 and neckband 805 and between augmented-reality system 800 and controller 825. The information may be in the form of optical data, electrical data, wireless data, or any other transmittable data form. Moving the processing of information generated by augmented-reality system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 900 in FIG. 9, that mostly or completely covers a user's field of view. Virtual-reality system 900 may include a front rigid body 902 and a band 904 shaped to fit around a user's head. Virtual-reality system 900 may also include output audio transducers 906(A) and 906(B). Furthermore, while not shown in FIG. 9, front rigid body 902 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 800 and/or virtual-reality system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 800 and/or virtual-reality system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 800 and/or virtual-reality system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A display system, comprising:
a diffuser having a curved surface;
a display device positioned to emit light that is focused on the curved surface of the diffuser;
at least one viewing optic; and
an eye box;
wherein:
the light focused on the curved surface of the diffuser has a first cone angle and is diffused by the diffuser such that light output from the diffuser has a second cone angle;
the second cone angle is larger than the first cone angle; and
the light output from the diffuser propagates through the at least one viewing optic to the eye box.

2. The display system of claim 1, wherein the diffuser is reflective.

3. The display system of claim 2, further comprising a beamsplitter positioned between the diffuser and the eye box, wherein:
the light emitted from the display device is reflected from a surface of the beamsplitter toward the curved surface of the diffuser, and
the light output from the diffuser transmits through the beamsplitter.

4. The display system of claim 1, wherein the diffuser is transmissive.

5. The display system of claim 1, wherein the light emitted from the display device and focused on the curved surface of the diffuser forms an intermediate image on the curved surface of the diffuser.

6. The display system of claim 1, wherein the light that propagates through the at least one viewing optic forms a final image that is viewable at the eye box.

7. The display system of claim 1, wherein:
the display device comprises a projector having a scanning mirror; and
the scanning mirror reflects light from the projector toward the diffuser.

8. The display system of claim 7, wherein the projector comprises a focusing optic to focus light from the light source toward the scanning mirror.

9. The display system of claim 7, wherein the projector comprises a laser emitter.

10. The display system of claim 1, wherein the display device comprises at least one of a light-emitting diode (LED) display or a μLED display.

11. The display system of claim 1, wherein the display device comprises at least one of a laser projector or an LED projector.

12. The display system of claim 1, wherein the intermediate image is formed on a concave surface of the diffuser.

13. The display system of claim 12, wherein:
the diffuser is transmissive; and
the light forming the intermediate image on the concave surface of the diffuser propagates through the diffuser and is output from a convex surface of the diffuser.

14. The display system of claim 12, wherein;
the concave surface of the diffuser is reflective; and
the light forming the intermediate image on the concave surface of the diffuser is reflected from the reflective surface of the diffuser.

15. The display system of claim 14, wherein the light forming the intermediate image on the concave surface of the diffuser is diffused through a layer coating the reflective surface of the diffuser.

16. The display system of claim 1, wherein the at least one viewing optic further comprises a beamsplitter.

17. A display system, comprising:
a diffuser having a curved surface; and
a display device positioned to emit light that is focused on the curved surface of the diffuser, wherein:
the light focused on the curved surface of the diffuser has a first cone angle and is diffused by the diffuser such that light output from the diffuser has a second cone angle; and
the second cone angle is larger than the first cone angle.

18. The display system of claim 17, wherein the diffuser is reflective.

19. The display system of claim 17, wherein the diffuser is transmissive.

20. A method, comprising:
positioning a display device;
positioning a curved diffuser so that light emitted from the display device is focused on a concave surface of the curved diffuser; and
positioning viewing optics so that light output from the curved diffuser is directed to an eye box of the display system.
